(19) United States
(12) Patent Application Publication
(10) Pub. No.: US 2024/0317618 A1
(43) Pub. Date: Sep. 26, 2024

(54) METHOD AND APPARATUS FOR SEPARATING VAPOR,HEAT,AND VOLATILES FROM LIQUID MIXTURE

(71) Applicant: NEWhub Holding Company, Herndon, VA (US)

(72) Inventors: Eugenio Giraldo, Robbinsville, NJ (US); Sudhir Murthy, Herndon, VA (US); Nicolas Giraldo Wingler, Robbinsville, NJ (US)

(21) Appl. No.: 18/611,955

(22) Filed: Mar. 21, 2024

Related U.S. Application Data
(60) Provisional application No. 63/453,498, filed on Mar. 21, 2023.
(60) Provisional application No. 63/545,166, filed on Oct. 21, 2023.

(51) Int. Cl. C02F 3/00; C02F 1/20

(52) U.S. Cl. CPC C02F 3/006; C02F 1/20; C02F 2209/24

(57) ABSTRACT

This invention discloses a method of separating volatile acids and bases from liquid mixtures in wastewater treatment and aerobic culturing processes. The method uses the colligative properties of a solution to differentially separate solvent and acid vapors and employs novel techniques such as controlled volatilization, ion separation processes, and pH management to effectively remove these compounds while optimizing process efficiency. The invention facilitates the management of carbon dioxide accumulation, crucial for promoting autotrophic reactions and improving overall system performance.

### FILED OF THE INVENTION

The present invention relates to a method for managing volatile compounds in a wastewater treatment or an aerobic or anaerobic culturing process. More specifically, the present invention relates to a method for removing acidic or basic constituents from liquid mixtures to produce salts or salt solutions, aiming to improve the efficiency and sustainability of wastewater treatment and other culturing operations.

### BACKGROUND OF THE INVENTION

Culturing processes, including those present in wastewater treatment processes generate various volatile compounds, including acidic or basic substances such as carbon dioxide, volatile fatty acids, hydrogen sulfide, and ammonia. These compounds derive from a liquid mixture (or mixed liquor when referring to the liquid suspension in the liquid mixture) need management at different stages of treatment in a wastewater treatment process, such as from sewers, primary tanks, aeration tanks, clarifiers effluent, sludges, fermentation, digestion, thickening, dewatering, drying, pyrolysis or gasification or hydrothermal liquefaction. The characteristics of treatment tanks, including shape, size, depth, surface area, agitation, and headspace, can influence the management of these volatiles and impact the efficiency of treatment processes. Chemical interactions of these constituents within reactors can also affect reaction rates and biological processes, posing challenges in achieving optimal performance.

Conventional methods for managing volatile compounds in wastewater treatment processes face significant challenges. Product inhibition often limits the concentration of acids in the fermentation or aerobic broth/culture (liquid mixture), impacting reaction rates and yields. Attempts to continuously remove acids (such as volatile fatty acid or carbonic acid (carbon dioxide)) from the fermentation or aerobic broth/culture to alleviate inhibition/or substrate limitation have been proposed but face technical challenges. Additionally, separating acids from the fermenting broth is technologically challenging, requiring complex membrane technologies prone to fouling. Distillation for concentrating acids to commercial levels is energy-intensive, particularly due to the formation of azeotrope mixtures like acetic acid and water. These technical challenges hinder the development of cost-effective and sustainable methods for managing volatile compounds in wastewater treatment processes.

The need for improved methods for managing volatile compounds in wastewater treatment processes and other culturing processes arises from the limitations of existing solutions. Challenges such as product inhibition, membrane fouling, and energy-intensive distillation processes hinder the efficiency and sustainability of wastewater treatment processes. The present invention aims to overcome these shortcomings by introducing a novel method for managing volatile compounds in wastewater treatment processes. The innovative approach addresses these challenges and develops more effective and environmentally friendly methods for managing volatile compounds in wastewater treatment processes and aerobic or anaerobic culturing processes.

### SUMMARY OF THE INVENTION

In light of the above shortcoming, the present invention discloses a method of separating acid and basic compounds from liquid mixtures.

In an aspect of the present invention, a method for separating an acid or basic compound or compounds in a liquid mixture is disclosed. The liquid mixture can be derived from any aerobic or anaerobic culture from a production or treatment facility, including for example a food waste fermenter, aquaculture, or any part of a wastewater treatment plant. The method includes obtaining the liquid mixture at a predetermined pH range or sufficiently low pH for an acid or sufficiently high pH for a base, such that at least a fraction of the acid or basic compounds are in a volatile form (such as but not limited to VFA), wherein the liquid mixture includes a solvent, the acid or basic compounds, and other substances (typically particulate matter containing substrates, products and microorganisms). Evaporating a portion of the liquid mixture to form a first evaporate containing at least one molecule of the acid or basic compounds and at least one molecule of the solvent. Contacting the first evaporate with a hot scrubbing liquid to absorb at least one molecule of the acid or basic compound or compounds into the hot scrubbing liquid. Converting the acid or basic compound or compounds absorbed in the hot scrubbing liquid into an ionic form as part of becoming other compounds. Maintaining the temperature and pressure of the hot scrubbing liquid to form a second evaporate, substantially devoid of the acid or basic compounds by one of: a) minimizing condensation of solvent vapors obtained from at least one molecule of the solvent present in the first evaporate, and b) inducing evaporation in the hot scrubbing liquid, if condensation of the solvent of the first evaporate occurred. Collecting the second evaporate for one of: processing, discharge, and partly or fully sending the second evaporate to the liquid mixture.

In one embodiment, a pH range of the hot scrubbing liquid is maintained at a set point, or in a range, or a deadband by adding an acid or a base. Herein, when scrubbing an acid the pH range is from 5.7 to 9 and when scrubbing a base the pH range is from 8.2 to 5.

In one embodiment, any part of the evaporate or evacuate, of or from the liquid mixture, containing either heat, vapor, or volatile are separately managed or comanaged to effect cooling, volatile recovery or discharge in first evaporate, vapor recovery or discharge in second evaporate, or heat recovery or discharge from first or second evaporate, with any part or comanaged combination of heat, vapor or volatile being returned to the Liquid mixture.

In one embodiment, at least a fraction of the second evaporate is condensed to form a condensate and a non-condensable evaporate. Herein heat is released during the condensation of the second evaporate.

In one embodiment, at least a fraction of the heat released during the condensation of the second evaporate is recovered for further use, including, for evaporation of at least a portion of the liquid mixture.

In one embodiment, the heat released during the condensation is recovered using a heat pump or a vapor recompression unit.

In one embodiment, the liquid mixture is maintained at the pre-determined pH by adding the acid or base, wherein a minimum of 1%, or in some cases, at least 5%, or preferably at least 10% o of the acid or base exists in a volatile or unionized state.

In one embodiment, the liquid mixture can be contained in a tank or equipment or a series of tanks or equipment, including for such processing or treatment of liquid mixture, and for evacuation or evaporation from part or all of the liquid mixture, and is obtained from any part of a wastewater treatment plant, or an anaerobic or aerobic culture including food waste, aquaculture, a bioreactor, or a leach bead.

In one embodiment, the bioreactor is a fermenter sourcing the liquid mixture and the first evaporate contains at least one of volatile fatty acids, or an amine, or ammonia or carbon dioxide.

In an embodiment, the liquid mixture is passed through a liquid-solid separator prior to the evaporation forming a fraction rich in solids or culture, and a fraction rich in liquid. Herein the fraction rich in solids or culture is optionally returned to the bioreactor and the fraction rich in liquid is subjected to evaporation.

In one embodiment, adding a dilution-elutriation liquid to a unit process or culture process containing the liquid mixture.

In one embodiment, the concentration of the hot scrubbing liquid is maintained by removing a fraction of the hot scrubbing liquid and replacing it with fresh solvent.

In one embodiment, the acid or the base is generated from the hot scrubbing liquid by an ion separation process, including an electrodialysis process.

In one embodiment, condensation in the hot scrubbing liquid is allowed and the condensate is removed from the hot scrubbing liquid by a membrane process including but not limited to reverse osmosis, nanofiltration or electrodialysis.

In another aspect of the present invention a method for separating or controlling acidic carbon dioxide in a liquid mixture and to prevent its accumulation. The method includes obtaining the liquid mixture at a predetermined pH such that at least a fraction of an acid or basic compounds is in a volatile form, collecting a headspace, or alternatively stripping, or evaporating a portion of the liquid mixture forming an evaporate (or an evacuate) containing at least one molecule of the acid compound or carbon dioxide. Herein, in a specific embodiment of interest, the carbon dioxide accumulation occurs during the respiration of one of: pure oxygen oxygenation of a biological wastewater treatment process or an aerobic culture process or an aquaculture process (as examples of aerobic liquid mixtures). The terms evaporate or evacuate are used interchangeably and any location where each term is used, can be replaced by the other term. The means for such evaporation or evacuation can include different approaches as described herein. The constituents of such evacuate or evaporate include heat, vapor and volatiles as disclosed and defined herein

In one embodiment, the source of pure oxygen is from hydrolysis, or wherein the carbon dioxide is recovered and one of: reused or sequestered. The water source for such hydrolysis can be obtained from the water purification of the liquid mixture as one embodiment.

In one embodiment, the stripping of carbon dioxide occurs by spray stripping, packed tower stripping or bubble stripping or venturi stripping.

In one embodiment, a mixed liquor (an example liquid mixture) is collected from the tanks, internal mixed liquor recycle or from a return activated sludge stream of a wastewater treatment process, aerobic culture process or an aquaculture process.

In one embodiment, the stripping process is controlled by monitoring the concentration of carbon dioxide directly or the pH of the decarbonated mixed liquor.

In another aspect of the present invention, a method for controlling carbon dioxide accumulation during pure oxygen oxygenation of a biological wastewater treatment process or an aquaculture process is disclosed. The method includes obtaining a gaseous headspace in an oxygenation or aeration equipment or tank, the gaseous headspace is rich in carbon dioxide, selecting a portion in the gaseous headspace, removing at least a fraction of the carbon dioxide in the selected portion by forming a decarbonated gas stream and returning the decarbonated gas stream to the biological wastewater treatment process, aerobic culture process or aquaculture process or discharging the decarbonated gas stream.

In one embodiment, the decarbonization of the gas stream is controlled by measuring carbon dioxide in the gas stream by monitoring pH in the wastewater treatment of aquaculture process or both.

These elements, together with the other aspects of the present invention and various features are pointed out with particularity in the claims annexed hereto and form a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description taken in conjunction with the accompanying drawing, in which:

FIG. 1 illustrates an example of a process flow diagram of the present invention;

FIG. 1B illustrates the impact of dissolved salt concentration on the boiling point of water solvent in a concentrated salt solution of Calcium Acetate, in accordance with an exemplary embodiment of the present invention;

FIG. 1C illustrates an exemplary inlet concentration of gas to a scrubber in contact with a hot scrubbing liquid symbolized in the figure by a droplet;

FIG. 1D illustrates an exemplary outlet concentration of gas from the scrubber where equilibrium between the liquid and the gas phases for solvent and acid has been achieved and no net exchange of solvent or acid between the phases takes place;

FIG. 2 illustrates a process for separating a volatile base in a liquid mixture (L), in accordance with an exemplary embodiment of the present invention;

FIG. 2B illustrates a temperature-controlled vessel to induce acid fermentation of a fermentable organic material, in accordance with an exemplary embodiment of the present invention;

FIG. 3 illustrates a mechanical vapor recompression system where heat is supplied to the evaporator in parts, in accordance with an exemplary embodiment of the present invention;

FIG. 4 illustrates the integration of the vapor recompression unit to both the evaporator process and a leach bed unit, in accordance with an exemplary embodiment of the present invention;

FIG. 5 illustrates a flash evaporator and a vacuum pump used in the process to facilitate evaporation and concentration of the liquid mixture, in accordance with an exemplary embodiment of the present invention;

FIG. 6 illustrates the vacuum evaporation process of a mixture containing volatile acids or bases (with VFA) and their collection on a sodium bicarbonate scrubbing solution while conducting evaporation at varying pH levels;

FIG. 7 illustrates a method where the base used for controlling pH in the hot scrubbing liquid salt is formed by circulating a portion of the hot scrubbing liquid from the reservoir through an ion separation process;

FIG. 8A illustrates a spray stripping unit where water or a slurry containing carbon dioxide is sprayed into a vessel, in accordance with an exemplary embodiment of the present invention;

FIG. 8B depicts a bubble stripping unit where draw gas is bubbled through liquid containing carbon dioxide, in accordance with an exemplary embodiment of the present invention;

FIG. 8C illustrates another embodiment of a spray stripping unit where liquid spray or slurry spray is introduced into a conduit transporting gas with low carbon dioxide concentration, in accordance with an exemplary embodiment of the present invention;

FIG. 8D illustrates a venturi stripping unit where liquid carrying excess carbon dioxide is forced through a venturi inducing a sudden drop in pressure, in accordance with an exemplary embodiment of the present invention;

FIG. 8E illustrates a packed bed stripping unit where liquid is distributed on a packed bed allowing it to percolate down, in accordance with an exemplary embodiment of the present invention;

FIG. 9 illustrates a wastewater treatment plant, in accordance with an exemplary embodiment of the present invention;

FIG. 10 illustrates the placement of a stripping unit within an internal mixed liquor recycle loop that collects mixed liquor from the pure oxygen aeration basin with accumulated carbon dioxide, in accordance with an exemplary embodiment of the present invention;

FIG. 11 illustrates the accumulation of carbon dioxide in the gaseous headspace of a wastewater treatment process within the aeration basin during pure oxygen addition, in accordance with an exemplary embodiment of the present invention;

FIG. 12 illustrates the placement of a stripping unit within an internal mixed liquor recycle loop in an aquaculture process, in accordance with an exemplary embodiment of the present invention;

FIG. 13 illustrates the application of carbon dioxide accumulation control in an aquaculture process, in accordance with an exemplary embodiment of the present invention;

FIG. 14 illustrates a hydrolysis process used for hydrogen production, in accordance with an exemplary embodiment of the present invention;

FIG. 15 illustrates a block diagram of a process flow of the present invention;

Like reference numerals refer to like parts throughout the description of several views of the drawing.

### DETAILED DESCRIPTION OF THE INVENTION

Embodiments are provided so as to thoroughly and fully convey the scope of the present invention to the person skilled in the art. Numerous details are set forth, relating to specific components, and methods, to provide a complete understanding of embodiments of the present invention. It will be apparent to the person skilled in the art that the details provided in the embodiments should not be construed to limit the scope of the present invention. In some embodiments, well-known processes, well-known apparatus structures, and well-known techniques are not described in detail. Some tanks or processing elements may be missing from a figure, but those skilled in the art would understand these needs.

The terminology used, in the present invention, is only for the purpose of explaining a particular embodiment and such terminology shall not be considered to limit the scope of the present invention. As used in the present invention, the forms “a,” “an,” and “the” may be intended to include the plural forms as well, unless the context clearly suggests otherwise. The terms “comprises,” “comprising,” “including,” and “having,” are open-ended transitional phrases and therefore specify the presence of stated features, integers, steps, operations, elements, modules, units, and/or components, but do not forbid the presence or addition of one or more other features, integers, steps, operations, elements, components, and/or groups thereof. The particular order of steps disclosed in the method and process of the present invention is not to be construed as necessarily requiring their performance as described or illustrated. It is also to be understood that additional or alternative steps may be employed.

The term “VFA (1)” refers to volatile fatty acids including but not limited to propionic, butyric, and valeric, derived from organic compounds using mixed acid fermentation.

In an aspect, the present invention introduces a method for separating volatile compounds from liquid mixture (L), particularly in wastewater treatment and aquaculture processes. The method effectively mitigates carbon dioxide accumulation, addressing challenges in pH control and biological process inhibition. By incorporating surplus oxygen from electrolysis plants and managing carbon dioxide levels, the invention offers a comprehensive solution for sustainable wastewater treatment and aquaculture, enhancing productivity and environmental benefits.

The present invention enables the separation of acids, or other volatile compounds (any such acid or base from a wastewater stream) that exhibit an acid-base reaction, from a liquid mixture to produce a salt or salt solution of the volatile acid or volatile base compound, and furthermore as an additional embodiment, that salt or salt solution having commercial value or benefiting the environment. In some cases the liquid mixture (L) could be waste material of industrial processes, while in other cases the liquid mixture (L) could be all or a fraction of a fermentation broth or an aeration tank. Integration with mixed acid fermentation broth is particularly effective but it could also be integrated with other fermentations or biological transformations in bioreactors as long as volatile acids or bases are present. Integration of the current invention with mixed acid fermentation processes overcomes the three main technical challenges described previously to cost effectively recover VFA or such types of volatile acids or bases (including CO2, H2S, NH3) from waste organic materials. Yet in other cases vaporization of carbon dioxide is of interest as carbonic acid depresses pH in some wastewater treatment or aquaculture application inhibiting for example, substrate (inorganic carbon) use in biological processes such as nitrification or aquatic culture yields.

Another application of the present invention is described. During the use of pure oxygen oxygenation for the treatment of wastewater, or for oxygen supply in aquaculture, or in any biological process needing oxygen, carbon dioxide is produced as a result of oxygen utilization. During wastewater treatment oxidation of carbonaceous compounds by microorganisms, carbonaceous BOD, release carbon dioxide, in aquaculture oxygen is used by fish or shrimp or other aquatic organisms for respiration similarly releasing carbon dioxide to the water. Decomposition of waste materials from said aquatic organisms also contributes to the release and accumulation of carbon dioxide in aquaculture water. Other large scale culturing of bacteria or higher organisms could exist (such as vermiculture, fungiculture, etc) where oxygen is needed and CO2 is produced. In almost all of these cases, the use of pure oxygen, limits the release of carbon dioxide, and its desired release needs to be promoted to manage the biological reaction rates especially of autotrophs and chemotrophs. Often the type of oxygenation equipment used to inject pure oxygen to water limits stripping of carbon dioxide from the liquid and carbon dioxide accumulates.

In other important cases (and included as an embodiment), such as deep tanks, covered tanks, or for efficient air supply or high microbial inventory; these conditions also cause the accumulation of carbon dioxide in the liquid (herein, the supply of oxygen is not from pure oxygen, but from air).

Any approach or condition that results in such dissolution of carbon dioxide is sometimes counterproductive. Carbon dioxide dissolved in water forms carbonic acid that depresses pH inhibiting for example nitrifying organisms which in the case of wastewater is undesirable outcome when such nitrification or nitrogen removal from wastewater is required. Carbon dioxide accumulation also interferes with separation of sludge in clarifiers impacting the overall capacity of the plant. Depression of pH is not a desirable outcome in aerobic culturing, including aquaculture, vermiculture, some fungiculture applications and for the manufacture of single cell protein or multi cell protein, as it impacts bacteria, aquatic and eukaryotic organisms wellbeing and productivity. Often, such well-being (as measured by growth rates or yield) is linked to the protonation effects of compounds in the water.

There is an increased interest in the use of pure oxygen for wastewater treatment and aerobic culturing (including and not limited to aquaculture) due to current efforts to decarbonize the economy. The use of hydrogen produced from electrolysis of water using renewable energy is currently being considered directly as a fuel or indirectly as intermediate compound for chemicals production. For example, ammonia is being produced from hydrogen in green ammonia plants where is considered either as a fuel for power and transportation or as an industrial chemical. Oxygen is produced as a byproduct of electrolysis and is expected that a surplus of oxygen will become available from electrolysis plants. Wastewater and aerobic culturing (such as aquaculture) are likely users of the surplus oxygen. The present invention provides a way of controlling accumulation of carbon dioxide in wastewater plants and aquaculture applications by stripping it and optionally collecting it. Thus, the use of some or all of the oxygen, recovered as a product of such electrolysis for hydrogen production, in wastewater treatment or in an aerobic culturing step, and the facilitated removal of carbon dioxide produced thereof to moderate the pH is collectively inventive as per our disclosure. In an additional embodiment, the trapping of such carbon dioxide in an alkaline (including a base or an amine salt) medium and its sequestration thereof is an additional inventive disclosure.

In some of the figures and associated descriptions below, the liquid mixture containing tank or device or equipment is not shown (this tank or equipment is a familiar aspect to the art). However, this tank or a device or equipment with such mixture, producing the acid or base thereof, should be assumed (but not shown) and in claims could be an essential feature. In other cases, the liquid mixture tank is shown as an example embodiment, such as an aeration basin. Again, this basin is an embodiment of an approach to hold an aerobic culture in a batch, semi-batch or continuous manner, and the basin could be for any aerobic culture approach. The term mixed liquor is often used specifically for aeration basins holding activated sludge. Herein, this term indeed can be used for activated sludge, but is also more expansive from a perspective of other liquors holding aerobic cultures and is analogous to the liquid mixture term also used.

In some figures the evacuation tank/equipment is not shown. Again, here, this tank/equipment (used for applying a vacuum or for stripping) should be assumed as this is reasonable for those familiar in the art of vapor, heat and volatile recovery. So, a concept could include two equipment for liquid mixture containing the biological reaction tank/equipment and the evacuation tank/equipment.

The use of pure oxygen in an aerobic culture can be replaced with air or a mixture of the two (enriched air) in different proportions. Thus, all references to pure oxygen can be replaced with air for situations where carbon dioxide sufficiently accumulates to depress the pH. In other cases, pure oxygen is an essential reactant, especially if this reactant makes the approach of aerobic culturing more efficient and cost effective or synergistic (such as with hydrolysis). Of course, a hydrolysis reaction will produce pure oxygen as one product and for use in such aerobic culturing. The reference to oxygenation can be replaced by the term aeration when air or enriched air is used.

The liquid mixture can be placed in any tank(s) or equipment(s) for anaerobic or aerobic culturing, and the pH of such mixture can be at as low a pH of 4 (anything between 4 and neutral) when acids are being evacuated and as high a pH of 10 (anything between neutral and 10) when bases are being evacuated, thus maintaining a protonated or deprotonated state for the needed volatilization (protonated for acids and deprotonated for bases). The evacuation of such acids and bases can drive the liquid pH in the opposite direction (higher for acids and lower for bases), and thus a control can be setup to allow the culture to produce more acid or base to achieve a steady state condition. In some situations, this pH can be poised, or a deadband is establish between the evacuated pH and the pH produced by the culture. For example, the evacuation of carbon dioxide can increase the pH, and the nitrification reaction by nitrifiers can produce protons that depress the pH, thus achieving the ability through a control approach to poise the pH at a single value, maintain in a narrow deadband of less than 0.1 pH units or a provide the flexibility of a broad deadband of as much as 1 to 2 pH units. An external (i.e. not produced by the culture itself) acid or base can be augmented to maintain such pH. Two tanks/equipment can also be used to maintain the pH between two deadband values, where each tank (including an evacuation tank) is maintained at a preferred pH.

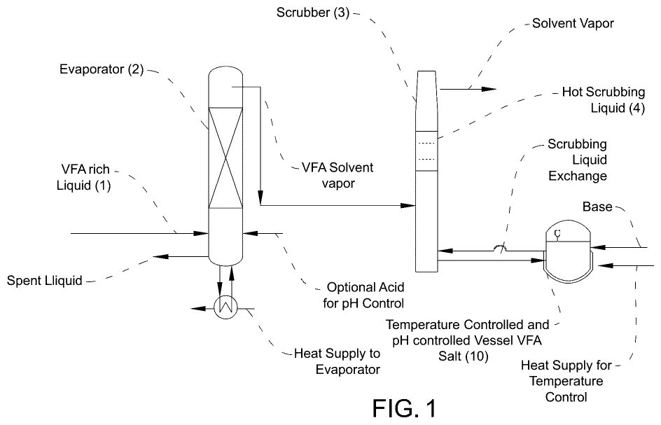

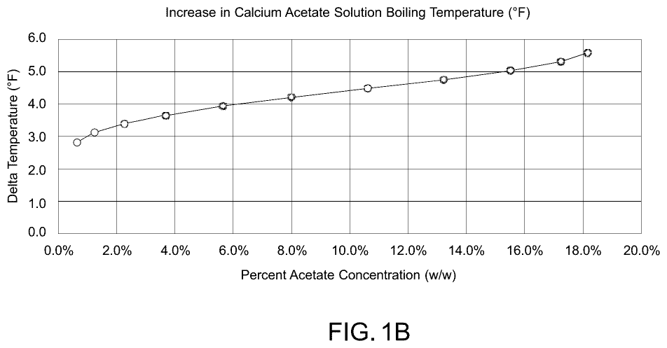

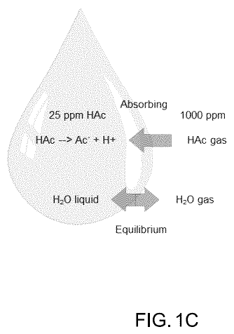

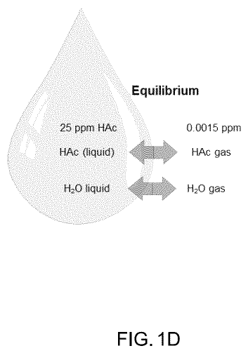

Referring now to FIG. 1, an example of a process flow diagram of the present invention is disclosed. A volatile acid or volatile base (herein VFA (1) as an example embodiment) rich liquid, a liquid mixture (L) containing volatile acid or volatile base (VFA (1) shown as an example embodiment), is conveyed to an evaporator (2) where it is heated to a temperature and pressure such that at least a fraction of the volatile acids are evaporated forming a first evaporate (2a). An acid, including but not limited to hydrochloric or sulfuric as there are others, is optionally added to keep the pH of the liquid mixture (L) in the evaporator (2) at a given set point, or a pH range, in such a way that at least a fraction of the volatile acids is protonated and could be evaporated. The liquid mixture is maintained at a predetermined pH range or sufficiently low pH for an acid or sufficiently high pH for a base. VFA (1) have a pKa of about 4.7 indicating that most of the VFA (1) are protonated below a pH of 4.7 while most are in deprotonated, in ionic form, above a pH of 4.7, it is advantageous then to maintain the pH as low as possible within other technical and practical considerations. Other volatile acids/bases will have different pKa and the VFA (1) is an example embodiment approach to describe protonation. Examples of volatile acids include but are not limited to, acetic, lactic, formic, butyric, propionic acid, carbonic acid (from carbon dioxide), sulfurous acid (from sulfur dioxide), hydrogen sulfide, and sorbic acids. Trace acids of value or of polluting nature are also possible. The non-protonated fraction, for example, acetate ion in the case of acetic acid, is not volatile for practical purposes and remains in solution. A portion of the solvent in the liquid mixture (L) is also evaporated in the process. For example, water and VFA (1) have similar boiling points and one would see both water vapor and VFA (1) vapors produced in the evaporator (2) system. There are many different types of evaporators including but not limited to a cooling tower, a forced circulation evaporator, a rising film or falling film evaporator, an agitated thin film evaporator, a multiple effect evaporator, or a self-cleaning evaporator, or further a flash evaporator, or others evident to someone skilled in the art according to the characteristics of the VFA (1) rich liquid.

The evaporator (2) is operated in different ways, for example, a batch mode, semi-batch mode, or continuous way. A spent liquid is produced after the evaporation process. The vapors produced in the evaporator (2) would have solvent vapor and acid vapor, for example water vapor and acetic acid (or other volatile acids or bases) vapor, or more generally a volatile acid or volatile base (acetic acid or VFA (1) shown as an example embodiment) vapor and a solvent vapor. It is important to collect the volatile acid or volatile base (VFA (1) shown as an example embodiment) solvent vapor to avoid condensation during conveyance implying that the lines should be heat insulated and heat-traced if necessary. The hot vapors are then transferred to a scrubber (3) that contacts said vapors with a hot concentrated solution of a volatile acid or volatile base (VFA (1) shown as an example embodiment) salt, for example calcium acetate or calcium carbonate, etc. Many different types of scrubbers can be used, for example, as can be others, a venturi scrubber could be used, or a spray scrubber, or a packed tower scrubber, someone skilled in the art could find a more appropriate scrubber for a particular application. The concentrated VFA (1) salt solution, the hot scrubbing liquid (4), has a temperature and pH such that VFA (1) vapors in contact with it will absorb, but it is hot enough and at a pressure such that solvent vapor, for example water vapor, is not condensed or marginally or largely condensed (as desired and if needed controlled) during the intimate contact between the two fluids, fluid vapors, and hot scrubbing liquid (4). The remaining evaporate after scrubbing is the second evaporate (2b) which is substantially devoid of volatile acid as it has been substantially absorbed during the hot (or temperature-controlled) scrubbing process. This second evaporate (2b) could be returned to the process reactor if heat conservation is desired, or separately condensed if cooling (or controlled cooling) is desired of that process stream (such as the liquid mixture).

FIG. 1B illustrates the impact of dissolved salt concentration on the boiling point of water solvent in a concentrated salt solution of Calcium Acetate as an example salt embodiment. Other salts (such as calcium carbonate from carbonation, calcium sulfide from hydrogen sulfide, calcium propionate from propionic acid, etc.) would have a similar effect. The increased boiling point of the concentrated salt solution enables operating the scrubber (3) at a temperature and pressure such that the acid vapors are absorbed while the solvent vapors, for example water vapor, are not condensed. For example, the graph illustrates an increase in the boiling point of calcium acetate (as an example salt embodiment) water solution of 5.5 degrees Fahrenheit at a concentration of 18% (w/w) of acetate. This is of practical significance as this type of temperature differential is easily achieved with existing control equipment.

FIG. 1C and FIG. 1D further illustrate two exemplary operational conditions of the liquid and the gas in a scrubber. FIG. 1C illustrates an exemplary inlet concentration of gas to a scrubber in contact with a hot scrubbing liquid symbolized in the figure by a droplet. FIG. 1D illustrates an exemplary outlet concentration of gas from the scrubber where equilibrium between the liquid and the gas phases for solvent and acid has been achieved and no net exchange of solvent or acid between the phases takes place. FIG. 1C further illustrates the hot scrubbing process that selectively absorbs a volatile acid present in the gas phase into a liquid phase while minimizing, or avoiding, solvent exchange between the liquid and gas phase. A droplet of hot scrubbing liquid is presented for illustration purposes. The temperature of the liquid is such that the vapor pressure of the solvent in the liquid and the gas phases is at equilibrium avoiding either condensation or evaporation of solvent. The pH of the liquid in the droplet is such that the vast majority of the acid is in the ionized, deprotonated form, and a net absorption of acid from the gas to the liquid takes place. Once the acid is absorbed into the hot scrubbing liquid symbolized by the droplet, the acid is ionized and is no longer volatile and remains in the liquid. FIG. 1D further illustrates a concentration of gas such that the small amount of protonated acid in the liquid phase is in thermodynamic equilibrium with the acid in the gas phase in such a way that no net exchange of acid between gas and liquid phase, this latter symbolized by a droplet, takes place. Similarly, the temperature of the hot scrubbing liquid is such that the solvent vapor pressure is in equilibrium between gas and liquid phases and no net exchange of solvent between the phases takes place. This condition is likely to occur in the effluent of a well-designed and well operated scrubber but other operational conditions might exist.

In FIG. 1 the scrubber (3) has a temperature-controlled and pH-controlled vessel (10) containing the VFA salt (an example salt embodiment), serving as a reservoir that exchanges fluid with the scrubber (3). In some scrubber (3) designs, this reservoir is an integral part of the scrubber (3) as is the case in spray scrubbers, or packed bed scrubbers, yet in other scrubber designs such as venturi scrubber an independent reservoir is provided. Heat is supplied to the reservoir as needed to control the temperature of the hot scrubbing liquid (4). Abase (as needed) is also added to control pH of the hot scrubbing liquid (4), concentrated VFA salt (as an example salt embodiment). Absorption of acid vapor into the hot scrubbing liquid (4) will depress the pH of the solution and a base is necessary to maintain the pH at a set point or within a range. A control subsystem is provided to adjust pH as needed. Upon absorption the acid becomes deprotonated donating the proton to depress pH and forming an anion, for example, acetate if the acid vapor is acetic acid, carbonate if the acid vapor is carbon dioxide or carbonic acid, sulfide if the acid vapor is hydrogen sulfide, and so on.

The volume of the hot scrubbing liquid (4) is monitored and if condensation of solvent is observed, releasing the heat of condensation into the hot scrubbing liquid (4), the temperature and or pressure of the hot scrubbing liquid (4) is adjusted to induce evaporation of the solvent an into the second evaporate (2b). A heat supply is provided to control the temperature as needed. The net effect is the formation of a salt of the acid, for example, calcium acetate (an embodiment of such salt combinations with other acids) if the acid vapor is acetic acid and the base used for pH control is calcium hydroxide. Other salts can be formed depending on the acid and the base (such as potassium hydroxide or sodium hydroxide). The pH of the hot scrubbing liquid (4) is maintained at a point or at a range such that the protonated fraction of the acid is minimized to reduce evaporation of the acid. In some embodiments, the pH is controlled at about 7 to 9 pH units, but it could be controlled at higher or lower depending on the operational considerations. The solvent vapor, water vapor in some embodiments, substantially devoid of VFA vapors, second evaporate (2b), is collected after the scrubbing process. In some embodiments, this second evaporate (2b) is all or a fraction returned to the liquid mixture (L), while in other embodiments it is condensed to recover the latent heat of condensation (and accomplishing upstream bioprocess cooling if so desired, thereof). The hot scrubbing liquid (4) increases in concentration over time as the vapors from the evaporator (2) are processed and some of the hot scrubbing liquid (4) is removed as a product. Make up fluid is added as needed. Yet in other cases the concentration is allowed to increase to the point where the solubility of the salt is reached at which point a precipitate is formed and said precipitate is removed as a product for disposal or preferably for recovery. In the case of VFA (1), the recovery of such acids as a special case is used as a carbon source for growing bacteria (including for any form of nitrogen removal or enhanced biological phosphorus removal) as a specific inventive step. In the case of carbon dioxide, the recovered stream is used for any form of carbon sequestration or as a carbonation stream as an inventive step.

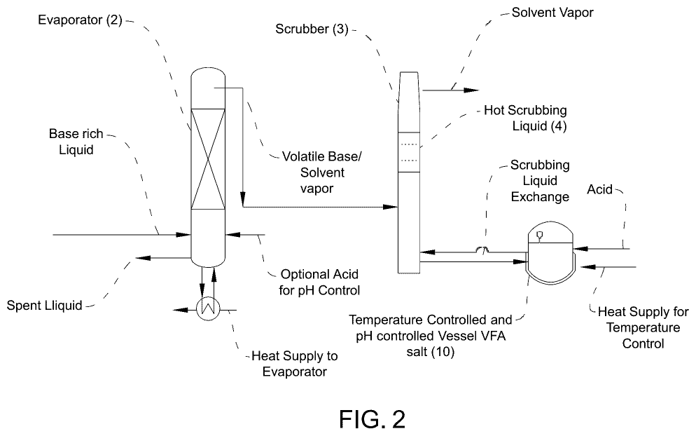

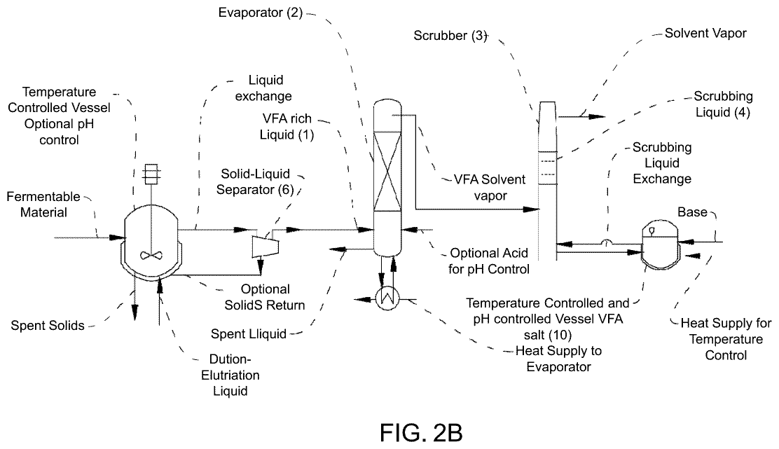

Referring to FIG. 2, another embodiment of the present invention for separating a volatile base in a liquid mixture (L). This embodiment is similar to the embodiment disclosed in FIG. 1 but, in this case, the liquid mixture (L) is rich in a volatile base including but not limited to ammonia or volatile amines produced during the fermentation of amino acids, including but not limited to methylamine, dimethylamine, trimethylamine, histamine, tyramine, spermidine, spermine, phenylethylamine, cadaverine, ammonia and putrescine. In this case, a base (as needed), such as but not limited to calcium hydroxide or sodium hydroxide, is used to control the protonation of the amine in the evaporating fluid instead of an acid as described in FIG. 1. In the case of amines the pKa is about 9.2 which implies that many of the amines are protonated (ionized and less volatile) at a pH below 9.2, while most of the non-protonated (and therefore unionized) volatile species is at a pH above 9.2. It is then more advantageous to induce evaporation of the amine compounds to have a high pH within the practical limits of other considerations. The pH of the hot scrubbing liquid (4) is controlled by adding an acid, such as but not limited to carbonic acid, sulfuric acid or hydrochloric acid, to the reservoir of hot scrubbing liquid (4), forming a salt for example methylamine sulfate if methylamine was scrubbed and sulfuric acid was used to control pH of the hot scrubbing liquid (4).

FIG. 2B represents another embodiment of the present invention similar to the embodiments described in FIG. 1 and FIG. 2 but further including a temperature-controlled vessel (10) to induce acid fermentation of a fermentable organic material such as but not limited to food waste, or sludge from wastewater treatment plants. The pH of the vessel is optionally controlled by adding an acid or a base. The contents of the vessel are conveyed to a solid liquid separator (6), such as but not limited to a screw press, or a centrifuge or a thickener or other equipment apparent to someone skilled in the art, producing a liquid fraction and a solid fraction, the liquid fraction rich in VFA (1) is directed to the evaporator (2) but it could also contain volatile bases such as but not limited to amines or azenes, while the solid fraction is optionally returned to the vessel. Dilution-Elutriation liquid is optionally added to the vessel to enhance removal of acids towards the evaporator (2). Said dilution-elutriation could be redirected from the scrubber (3) downstream, either as solvent vapor or after condensation of said solvent vapor into a liquid. Vaporization of the acid or the base is conducted similarly to the previous embodiments in FIG. 1 or FIG. 2 even though in FIG. 2B vaporization and capture of acids is illustrated.

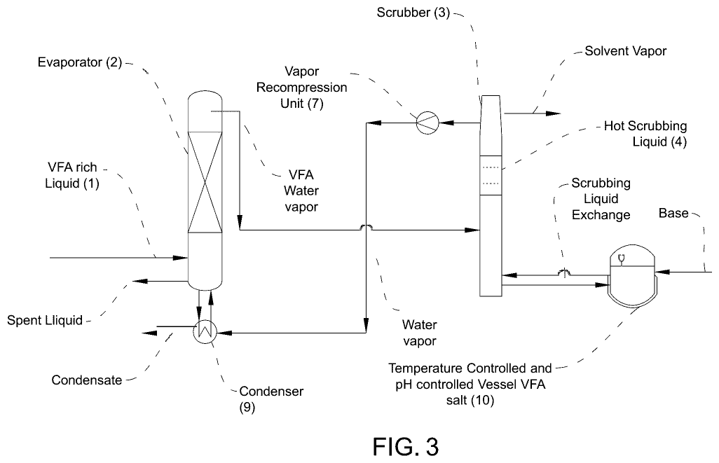

Referring to FIG. 3, another embodiment of the present invention where the heat supply to the evaporator (2) is provided at least in a fraction by a mechanical vapor recompression system. FIG. 3 is similar to FIG. 1 and FIG. 2 with the incorporation of a vapor recompression unit (7) that compresses and increases the temperature of the vapor substantially free of acid or base vapors after the scrubbing process, and where said compressed vapor is conveyed to a condenser (9) thermally connected to the evaporator (2). The vapor condenses and transfers the heat to the evaporating fluid in the evaporator (2) recovering the heat of vaporization/condensation and substantially reducing energy use of the process. A liquid condensate is produced at the condenser unit (9), and the non-condensable fluid passes through the condenser (9) forming a non-condensable evaporate.

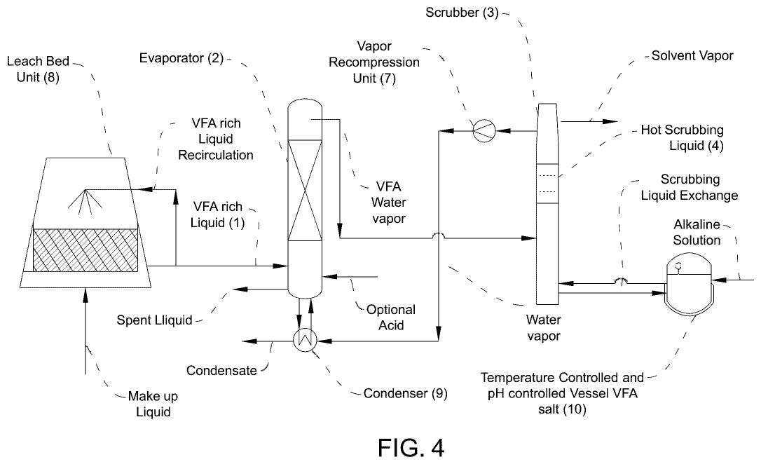

Referring to FIG. 4, a vapor recompression unit (7) is integrated into the evaporator (2) process for enhancing energy efficiency and also integrated with a leach bed unit (8) that is the source of the liquid mixture (L) rich in VFA (1). The leach bed unit (8) contains organic material that upon decomposition ferments and produces a leachate, which constitutes the liquid mixture (L) or the VFA (1) rich liquid. A fraction of the VFA (1) rich liquid leachate is optionally recirculated to induce further leaching of acids. Make-up water might also be added to further the acid-leaching process. The source of makeup water could be at least a fraction of the condensate from the vapor recompression condenser or the spent liquid from the evaporator (2), pH in the evaporator (2) can be optionally adjusted by adding an acid. One or more leaching units can be operated in series or in parallel and someone skilled in the art might find alternative ways of connecting the leaching bed units to optimize acid production and vaporization.

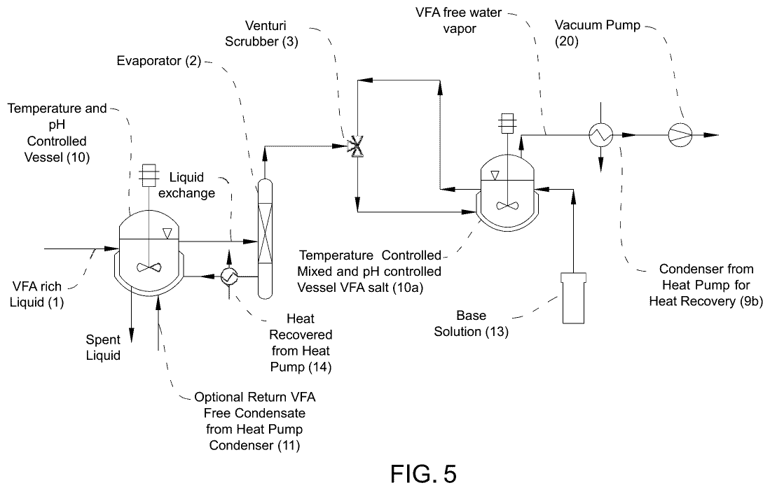

Referring to FIG. 5, another embodiment of the present invention, akin to earlier Figures, features a flash evaporator (2) and a vacuum pump (20). This embodiment is used when the evaporation process is conducted at low temperatures such as those needed when the VFA (1) or ammonia rich liquid contains microorganisms susceptible to damage at high temperatures. The low temperatures of evaporation also require the use of a vacuum pump (20) to induce the sub-atmospheric pressures for evaporation. This embodiment also illustrates the use of a heat pump (14) for energy recovery if so desired. The heat pump (14) is used to supply the cold fluid necessary for the condensation of the solvent vapors after removing the volatile acid or volatile base (VFA (1) shown as an example embodiment) vapors, illustrated in the FIG. 5 as volatile acid or volatile base (VFA (1) shown as an example embodiment) free water vapor, into a condenser (9). The condensed fluid produced in said condenser (9) is optionally returned to the temperature and pH controlled vessel (10) receiving the volatile acid or volatile base (VFA (1) shown as an example embodiment) rich liquid. Heat recovered during condensation is directed via the heat pump (14) into the evaporation process. A venturi scrubber (3) is presented in this embodiment as an example of a scrubber (3). Venturi scrubbers (3) provide the ability to have a differential vacuum pressure between the evaporator (2), and the hot scrubbing liquid (4) reservoir, temperature controlled, mixed and pH controlled volatile acid or volatile base (VFA (1) shown as an example embodiment) salt. This differential pressure created by the venturi scrubber (3) further enhances the ability to remove acid of base vapors in the scrubber (3) and controlling condensation of the solvent vapors. This embodiment illustrates the separation of volatile acid or volatile base (VFA (1) shown as an example embodiment) from a liquid mixture (L) but as previously described in FIG. 2 a similar embodiment is used for separation of volatile bases by changing adjusting the pH controls of both the evaporating liquid and the hot scrubbing liquid (4).

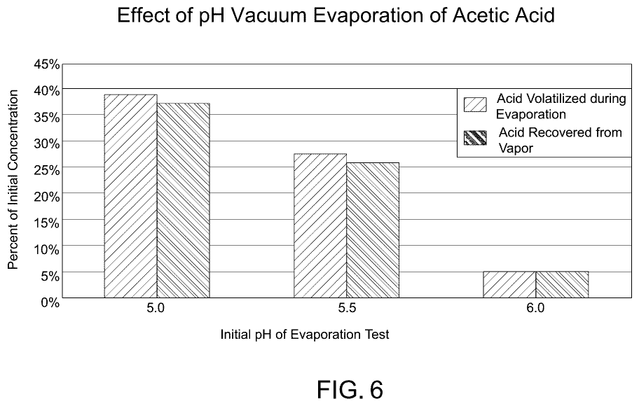

Referring to FIG. 6, the vacuum evaporation of a volatile acid or volatile base (VFA (1) shown as an example embodiment) mixture and collection on a sodium bicarbonate scrubbing solution when conducting evaporation at different pH. It is clear the previously highlighted effect of pH on the efficiency of acid evaporation and illustrates the high level of recovery achieved with the present invention.

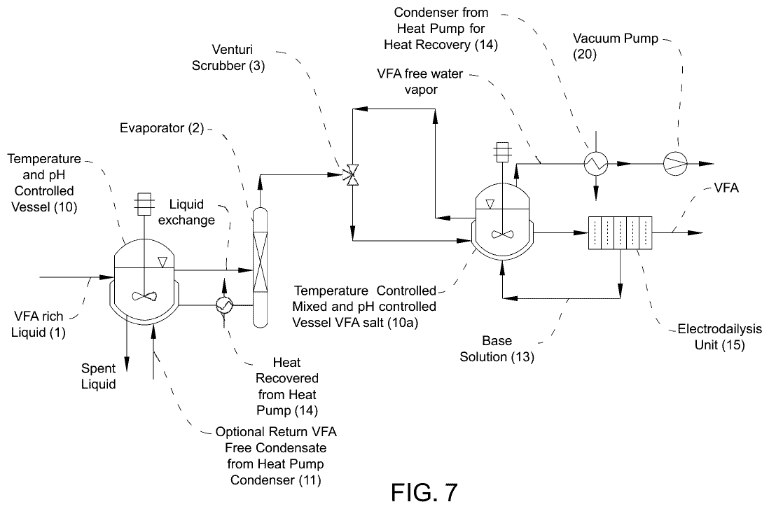

Referring to FIG. 7, an alternative embodiment of the present invention is disclosed. Here the base used for controlling pH in the hot scrubbing liquid (4) salt in FIG. 5 is formed by circulating a portion of the hot scrubbing liquid (4) from the reservoir through an ion separation process, such as an electrodialysis unit for example, as could be others, where the cation forming the base solution is returned to the hot scrubbing liquid (4) while the anion, the volatile acid (VFA (1) shown as an example embodiment), are collected as a product. Similarly, an ion separation unit (15) could be used when scrubbing a volatile base and the pH control on the hot scrubbing liquid (4) is with an acid solution, while the product is for example an amine as previously described. Yet in other cases instead of a ion separation process a dissolved ion concentration process such as nanofiltration or reverse osmosis is used to further concentrate the hot scrubbing liquid (4).

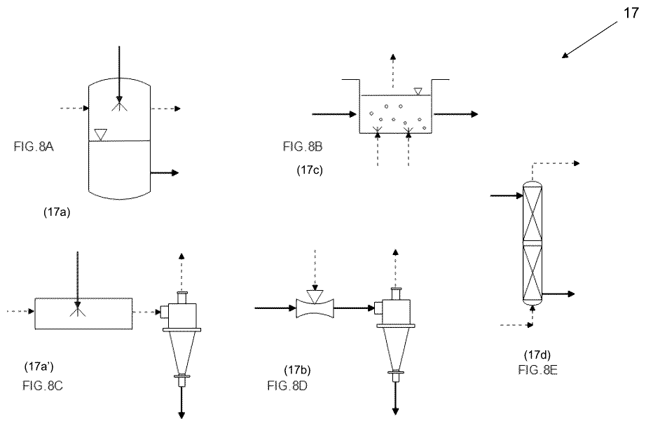

Referring now to FIG. 8A to 8E, a variety of different carbon dioxide (an example embodiment of a volatile acid) stripping equipment (17) that can be used as part of embodiments of the present invention is disclosed. In each of FIG. 8A to FIG. 8E the dotted arrows symbolize gas flow while the solid arrows symbolize a liquid flow or a slurry flow.

In FIG. 8A, a spray stripping unit (17a) where water, or a slurry, containing carbon dioxide is sprayed in a vessel where an atmosphere with low carbon dioxide content induces stripping from the liquid droplets into the gas. A gentle exchange of fresh gas to avoid carryover of liquid droplets removes the stripped carbon dioxide. The spray stripping unit (17a) can be operated under vacuum to enhance the kinetics of carbon dioxide stripping. In some cases, if carryover of droplets is experienced the outflow gas from the vessel can be further treated with a cyclone to collect the carryover droplets. The use of a cyclone for collection of liquid droplets is presented in FIG. 8C and FIG. 8D.

In FIG. 8C, another embodiment of a spray stripping unit (17a) where the liquid spray, or slurry spray, is introduced in conduit transporting a gas with a low concentration of carbon dioxide. Stripping occurs during the transport of the droplets to a cyclone where the droplets with lower concentrations of carbon dioxide are collected in the underflow and the gas carrying the stripped carbon dioxide is evacuated. The FIG. 8C spray stripping unit (17a) can be operated under vacuum to further enhance the kinetics of carbon dioxide stripping.

In FIG. 8D, the use of a venturi stripping unit (17b) where liquid carrying excess carbon dioxide is forced through a venturi inducing a sudden drop in pressure that draws a fresh amount of draw gas with low carbon dioxide concentration. The low pressure in the venturi enhances the kinetics of carbon dioxide stripping into the draw gas and the mixture of water and gas is separated in a cyclone downstream of the venturi.

In FIG. 8B, a bubble stripping unit (17c) where the draw gas is bubbled through the liquid containing the carbon dioxide; the draw gas with low carbon dioxide concentration collects the stripped carbon dioxide, and the gas exits the surface of the liquid vessel and can be optionally collected for further processing. A fraction of the liquid in the vessel is collected.

In FIG. 8E, a packed bed stripping unit (17d) where liquid is distributed on a packed bed at one or several locations allowing the liquid to percolate down the bed and collected at the bottom of the unit. Draw gas is introduced in counter current fashion in one or several locations of the packed bed and the intimate contact of the liquid and the gas induces stripping of carbon dioxide. The draw gas with the stripped carbon dioxide is collected and optionally further processed. This unit (17d) can also be operated under a vacuum to further enhance the kinetics of carbon dioxide stripping. The units (17) presented in FIG. 8A to FIG. 8E are exemplary carbon dioxide stripping units (17) as alternative units exist and someone skilled in the art might find a more appropriate unit for a particular application. FIG. 8A to FIG. 8E stripping unit (17) can also be used to remove carbon dioxide from a gas stream by contacting the carbon dioxide rich stream with a liquid that would absorb said carbon dioxide. In this case, the units will work not as a carbon dioxide stripping unit but as a carbon dioxide absorption unit.

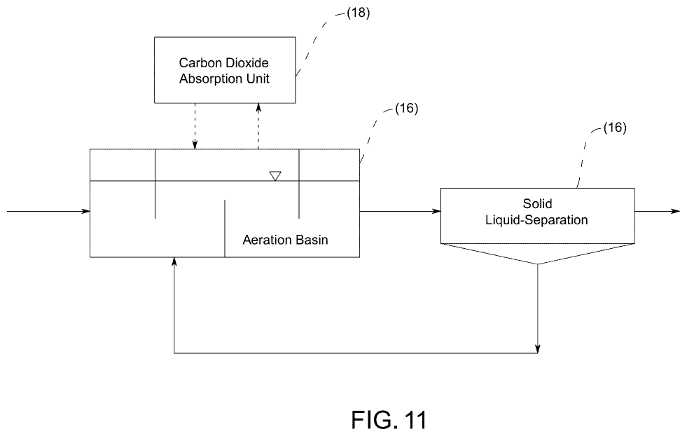

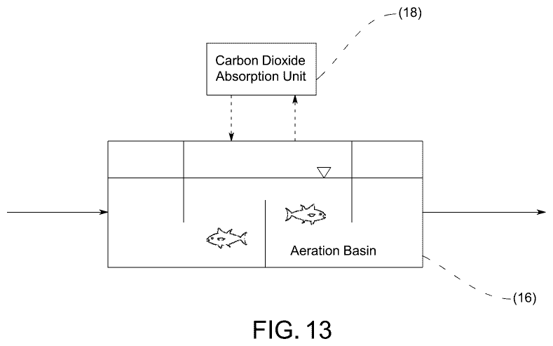

The application of the equipment described in FIG. 8A to FIG. 8E for carbon dioxide absorption from a gas stream is presented in FIG. 11 and FIG. 13 as part of the present invention. Referring to FIG. 11 and FIG. 13, the absorption of carbon dioxide from a gas stream at a wastewater treatment process, while FIG. 13 illustrates a similar application for an aquaculture process. Other technologies for carbon dioxide separation from a gas such as membrane technologies or solid absorption media exist and can be advantageously applied in particular applications. In all such Figures, carbon dioxide is an example embodiment of a volatile acid. Indeed, in the case of aerobic respiration, especially using pure oxygen (and sometimes air or enriched air), the evacuation of carbon dioxide becomes a necessary approach for such evacuation in order to maintain a healthy pH for the bacteria or other aerobic cultures in the process. This is especially key for organisms such as nitrifiers, and the culturing of certain fish, shellfish and fungi, or other single or multicellular protein. In one special embodiment within wastewater treatment, such pH management is linked to the use of inorganic carbon by nitrifiers or anammox for their growth as autotrophic organisms. These nitrifiers convert ammonia to nitrite or nitrate, key reactions within wastewater treatment, and the accomplishment of such reaction is a depolluting reaction. This reaction allows for further reactions such as denitrification or de-ammonification. In a specific embodiment, with the use of present invention, one can mitigate the formation of nitrous oxide by either modulating the supply of such oxygen or modulating the evacuation of carbon dioxide.

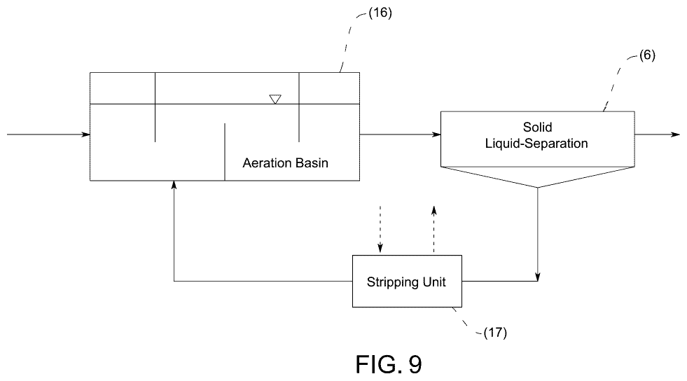

Referring to FIG. 9, an embodiment of the present invention in a wastewater treatment plant is disclosed. The solid arrows illustrate a liquid flow while dotted lines illustrate a gas flow. The aeration basin (16) contains a liquid mixture or mixed liquor, uses a pure oxygen (and possibly air or enriched air) aeration process and carbon dioxide accumulates in the liquid a result. The effluent from the aeration basin (16) is directed to a solid liquid-separation unit such as but not limited to a clarifier or a membrane and the separated solids are returned to the aeration basin (16). A stripping or evacuation unit (the term stripping and evacuation are henceforth used interchangeably even though they may have somewhat different yet analogous meanings), such as but not limited to a unit presented in FIG. 8A to FIG. 8E is located in the return stream of solids from the solid liquid separation unit and carbon dioxide is stripped, optionally collected and optionally further processed. After the evacuation or stripping process the return stream of solids is substantially decarbonated and the decarbonated mixed liquor is conveyed back to the aeration basin (16). The extent of the stripping can be optionally controlled by measuring the concentration of carbon dioxide in the aeration basin (16) or by using pH in the aeration basin (16) as an indicator of carbon dioxide accumulation. Such a management of pH assists with autotrophic reactions which use inorganic carbon as a carbon source. This includes the accomplishment of nitrification and anammox reactions associated with oxidation or removal of ammonia. This is a key embodiment of the invention that can be supported through the evacuation of carbon dioxide that is produces from respiration of such pure oxygen (and possibly air or enriched air depending on the tank and equipment and its agitation).

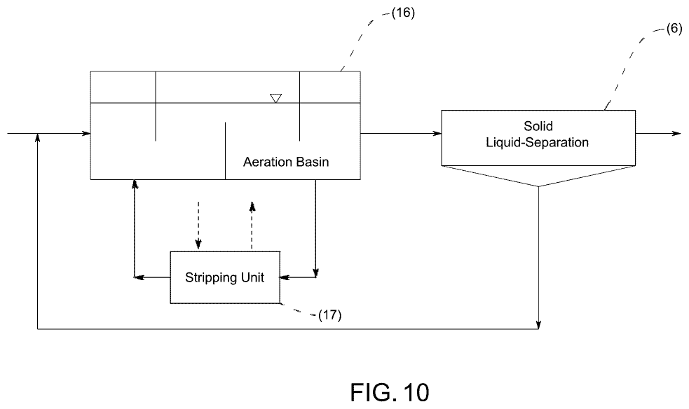

Referring to FIG. 10, where the stripping unit is located within an internal mixed liquor recycle loop that collects mixed liquor from the pure oxygen (and possibly air or enriched air depending on the tank and equipment and its agitation) aeration basin (16) contains a liquid mixture or mixed liquor with accumulated carbon dioxide, said mixed liquor is subject to stripping of carbon dioxide and returned to the aeration basin (16). A stripping unit (17), such as but not limited to a unit presented in FIG. 8A to FIG. 8E is used and carbon dioxide is stripped, optionally collected and optionally further processed. The extent of the evacuation or stripping can be optionally controlled by measuring the concentration of carbon dioxide in the aeration basin (16) or by using pH in the aeration basin (16) as an indicator of carbon dioxide accumulation.

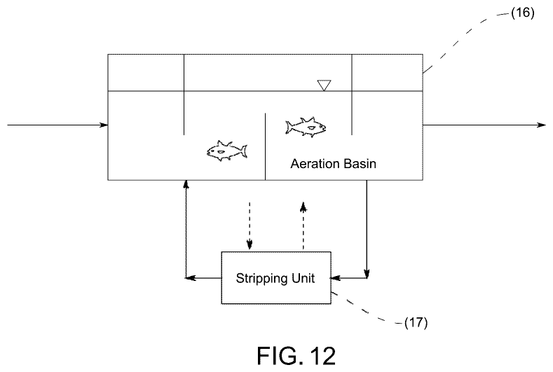

Referring to FIG. 12, which is a similar embodiment of FIG. 10 but illustrates an embodiment where the application of the present invention is an aquaculture (as an example liquid mixture embodiment of an aerobic culture process) process. A stream of liquid, mixed liquor, from the aquaculture vessel is collected and conveyed to the carbon dioxide stripping unit and returned to the aquaculture vessel after substantially removing carbon dioxide. The extent of the stripping can be optionally controlled by measuring the concentration of carbon dioxide in the aeration basin (16) (contains liquid mixture or mixed liquor) or by using pH in the aeration basin (16) as an indicator of carbon dioxide accumulation.

Referring to FIG. 11, where the aeration basin (16) that contains liquid mixture or mixed liquor, accumulates carbon dioxide released, evacuated, or stripped from the liquid during pure oxygen addition (the example could also be air or enriched air, used in the context of deep/covered tanks or where such carbon dioxide accumulates) but accumulates in a gaseous headspace of a wastewater treatment process. It has been reported that concentrations of up to 15% of carbon dioxide have been measured in the gaseous headspace. A stream of gas from said gaseous headspace rich in carbon dioxide is then collected and processed to substantially remove carbon dioxide in a carbon dioxide absorption unit (18) forming a decarbonated gas stream. Said decarbonated gas stream is returned after processing to the headspace to continue aeration. A multitude of technologies exist for absorbing carbon dioxide from a gas stream. In fact, the units used for carbon dioxide absorption are similar, although not limited, to the ones presented in FIG. 8A to FIG. 8E but working to absorb carbon dioxide from the gas stream into the liquid stream; a liquid is used to absorb the carbon dioxide from the gas stream. Membrane technologies exist for selectively separating the molecules of carbon dioxide from the gas stream and said membrane separation technologies can be used in this embodiment. Technologies for absorbing carbon dioxide into a solid sorbent also exist and someone skilled in the art will find a more appropriate technology for a particular application. The extent of carbon dioxide absorption in the absorption unit (18) can be optionally controlled by measuring the concentration of carbon dioxide in the gas stream or by using pH in the aeration basin (16) as an indicator of carbon dioxide accumulation. FIG. 13 is similar to FIG. 11 but illustrates an embodiment of the present invention where the application of the carbon dioxide accumulation control is on an aquaculture process. Other aerobic culturing process are possible as previously described

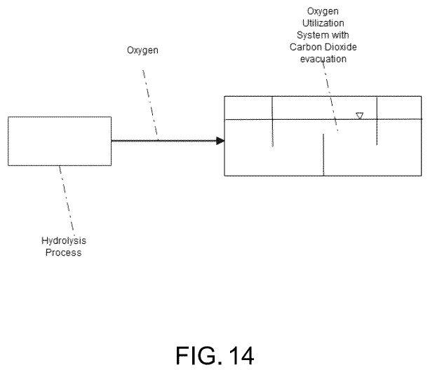

FIG. 14 considers the source of pure oxygen which is a hydrolysis process used for hydrogen production, wherein the pure oxygen sourced from such process, in part or in whole is sent to an oxygen utilization system as, an aeration basin (contains a liquid mixture or mixed liquor) of a wastewater treatment, aerobic culture, or aquaculture process or system. Additional sources of air or oxygen may be introduced as needed, and thus to enrich air or support a preferred aeration or oxygenation equipment embodiment of this invention. The carbon dioxide produced from such oxygenation is evacuated from the headspace or from the liquid using a stripper or a vacuum unit or any evacuation approach in order to maintain a healthy pH for the organisms consuming the oxygen that is at least in part sourced from the hydrolysis unit used to produce hydrogen. The evacuated carbon dioxide is harvested for sequestration as an additional approach as needed. A number of different approaches can be employed for evacuation or harvesting.

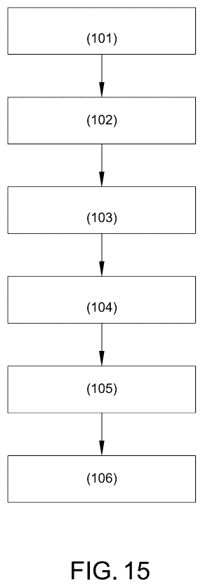

FIG. 15 illustrates a block diagram of the process flow of the present invention. The process includes a method for separating an acid or basic compounds in a liquid mixture (L). The method includes the following steps:
Step 1: Obtaining (101) the liquid mixture (L) at a predetermined pH range or sufficiently low pH for an acid or sufficiently high pH for a base, such that at least a fraction of the acid or basic compounds are in a volatile form (VFA (1)), wherein the liquid mixture (L) comprises a solvent, the acid or basic compounds, and other substances,
Step 2: Evaporating (102) a portion of the liquid mixture (L) to form a first evaporate (2a) containing at least one molecule of the acid or basic compounds and at least one molecule of the solvent,
Step 3: Contacting (103) the first evaporate (2a) with a hot scrubbing liquid (4) to absorb at least one molecule of the acid or basic compounds into the hot scrubbing liquid (4),
Step 4: Converting (104) the acid or basic compounds absorbed in the hot scrubbing liquid (4) into an ionic form as part of becoming compounds,
Step 5: Maintaining (105) the temperature and pressure of the hot scrubbing liquid (4) to form a second evaporate (2b), substantially devoid of the acid or basic compounds by one of a) minimizing condensation of solvent vapors obtained from at least one molecule of the solvent present in the first evaporate (2a), and b) inducing evaporation in the hot scrubbing liquid (4), if condensation of the solvent of the first evaporate (2a) occurred,
Step 6: collecting (106) the second evaporate (2b) for one of processing, discharge, and partly or fully sending the second evaporate (2b) to the liquid mixture (L).

From any of these figure referring to evacuation or stripping of carbon dioxide, the water stream from which the carbon dioxide is evacuated in a wastewater treatment process or system could be subject to sludge densification such as using a size, shear or density selector (such as a screen, hydrocyclone or such device) to allow the increase in the inventory of mixed liquor that is subject to efficient pure oxygenation in a synergistic manner.

Volatilization of acidic compounds are preferably carried out at least half to one pH unit below neutral pH (depending on the pKa of the acid), and in special cases of low pKa at least two pH units below neutral pH. Volatilization of bases is preferably carried out at least half to one pH unit above neutral pH (depending on the pKa of the base) and is special cases of high pKa, at least two pH units above neutral pH. In another approach and embodiment, the volatilization of acid or base compounds is preferably carried out when at least 10% of acid or base is in its unionized (or volatile) state. In some cases, this volatilization may need to be carried out when only 5% of acid or base is unionized.

The wastewater treatment processes that may be subject to such volatilization include and are not limited to unit process or equipment such as sewers, screens, grit tanks and de-gritting systems, primary tanks or clarifiers, aeration tanks, activated sludge tanks (including any anaerobic, anoxic or aerobic zones), bioreactors or biofilters, secondary clarifiers, media filters, reuse systems (including associated membranes and membrane tanks, clarifiers and filters), tertiary systems including clarifiers. Solids streams include thickening (Dissolved air flotation, centrifuge, screw, drums and belts), thermal hydrolysis, fermentation tanks (including enzymic processes), digesters (any form of aerobic or anaerobic or microaerobic), dewatering (including centrifuge, belt press, screw press), composting, drying (including biodrying where the heat from the evaporate is optionally reused), pyrolysis, gasification or hydrothermal liquefaction.

The choice of separate or comanagement of either heat, vapor or volatiles is a distinct embodiment described in this invention herein. This comanagement is described through the concept of first and second evaporate with appropriate heat extraction. Any aspect of managing heat, vapor or volatiles can precede each other, or the evaporation and condensation approach can be interchanged in space or time or sequence to allow for such separate or comanagement of such heat, vapor or volatiles for recovery or discharge or for inducing a desired performance of a liquid mixture containing such heat, vapor or volatiles.

The foregoing descriptions of specific embodiments of the present disclosure have been presented for purposes of illustration and description. They are not intended to be exhaustive or to limit the present disclosure to the precise forms disclosed, and many modifications and variations are possible in light of the above teaching. The embodiments were chosen and described to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the present disclosure.

1. A method for separating an acid or basic compound or compounds in a liquid mixture (L), the method comprising:
a. Obtaining (101) the liquid mixture (L) at a predetermined pH range or sufficiently low pH for an acid or sufficiently high pH for a base, such that at least a fraction of the acid or basic compounds are in a volatile form (VFA (1)), wherein the liquid mixture (L) comprises a solvent, the acid or basic compounds, and other substances;
b. Evaporating (102) a portion of the liquid mixture (L) to form a first evaporate (2a) containing at least one molecule of the acid or basic compounds and at least one molecule of the solvent;
c. Contacting (103) the first evaporate (2a) with a hot scrubbing liquid (4) to absorb at least one molecule of the acid or basic compound or compounds into the hot scrubbing liquid (4);
d. Converting (104) the acid or basic compounds absorbed in the hot scrubbing liquid (4) into an ionic form as part of becoming other compounds;
e. Maintaining (105) the temperature and pressure of the hot scrubbing liquid (4) to form a second evaporate (2b), substantially devoid of the acid or basic compounds by one of:
i. minimizing condensation of solvent vapors obtained from at least one molecule of the solvent present in the first evaporate (2a), and
ii. inducing evaporation in the hot scrubbing liquid (4), if condensation of the solvent of the first evaporate (2a) occurred,
f. collecting (106) the second evaporate (2b) for one of: processing, discharge, and partly or fully sending the second evaporate (2b) to the liquid mixture (L).

2. The method of claim 1, wherein a pH range of the hot scrubbing liquid (4) is maintained at a set point, or in a range, or a deadband by adding an acid or a base.

3. The method of claim 1, wherein any part of the evaporate or evacuate, of or from the liquid mixture (L), containing either heat, vapor, or volatile are separately managed or comanaged to effect cooling, volatile recovery or discharge in first evaporate (2a), vapor recovery or discharge in second evaporate (2b), or heat recovery or discharge from first or second evaporate (2b), with any part or comanaged combination of heat, vapor or volatile being returned to the Liquid mixture (L).

4. The method of claim 3, wherein at least a fraction of the second evaporate (2b) is condensed to form a condensate and a non-condensable evaporate, wherein heat is released or separately managed during the condensation of the second evaporate (2b).

5. The method of claim 4, wherein at least a fraction of the heat released during the condensation of the second evaporate (2b) is recovered for further use, including, for evaporation of at least a portion of the liquid mixture (L).

6. The method of claim 5, wherein the heat released during the condensation is recovered using a heat pump (14) or a vapor recompression unit (7).

7. The method of claim 1, wherein the liquid mixture (L) is maintained at the pre-determined pH by adding the acid or base, wherein a minimum of 1%, or in some cases, at least 5%, or preferably at least 10% of the acid or base exists in a volatile or unionized state.

8. The method of claim 1, wherein the liquid mixture (L) can be contained in a tank or equipment or a series of tanks or equipment, including for such processing or treatment of liquid mixture, and for evacuation or evaporation from part or all of the liquid mixture (L), and is obtained from any part of a wastewater treatment plant, or an anaerobic or aerobic culture including food waste, aquaculture, a bioreactor, or a leach bead.

9. The method of claim 8, wherein the bioreactor is a fermenter sourcing the liquid mixture (L) and the first evaporate (2a) contains at least one of volatile fatty acids, or an amine, or ammonia or carbon dioxide.

10. The method of claim 8, wherein the liquid mixture (L) is passed through a liquid-solid separator (6) prior to the evaporation forming a fraction rich in solids or culture, and a fraction rich in liquid, wherein the fraction rich in solids or culture is optionally returned to the bioreactor and the fraction rich in liquid is subjected to evaporation.

11. The method of claim 9, further comprising adding a dilution-elutriation liquid to a unit process or culture process containing the liquid mixture (L).

12. The method of claim 1, wherein the concentration of the hot scrubbing liquid (4) is maintained by removing a fraction of the hot scrubbing liquid (4) and replacing it with fresh solvent.

13. The method of claim 2, wherein the acid or the base is generated from the hot scrubbing liquid (4) by an ion separation process, including an electrodialysis process.

14. The method of claim 1, wherein condensation in the hot scrubbing liquid (4) is allowed and the condensate is removed from the hot scrubbing liquid (4) by a membrane process including but not limited to reverse osmosis, nanofiltration or electrodialysis.

15. A method for separating or controlling acidic carbon dioxide in a liquid mixture (L) and to prevent its accumulation, the method comprising:
a. obtaining the liquid mixture (L) at a predetermined pH such that at least a fraction of an acid or basic compounds is in a volatile form,
b. collecting a headspace, stripping, or evaporating a portion of the liquid mixture (L) forming an evaporate containing at least one molecule of the acid compound or carbon dioxide,
wherein the carbon dioxide accumulation occurs during the respiration of one of: pure oxygen oxygenation, or air aeration, or enriched air aeration in one of: a biological wastewater treatment process or an aerobic culture process or an aquaculture process.

16. A method of claim 15, wherein the source of pure oxygen is from hydrolysis, or wherein the carbon dioxide is recovered and one of reused or sequestered.

17. The method of claim 15, wherein the stripping of carbon dioxide occurs by spray stripping, packed tower stripping or bubble stripping or venturi stripping.

18. The method of claim 15, wherein a mixed liquor is collected from the tanks, internal mixed liquor recycle or from a return activated sludge stream of a wastewater treatment process, aerobic culture process or an aquaculture process.

19. The method of claim 15, wherein the stripping process is controlled by monitoring the concentration of carbon dioxide directly or the pH of the decarbonated mixed liquor.

20. A method for controlling carbon dioxide accumulation during pure oxygen oxygenation or air aeration or enriched air aeration of a biological wastewater treatment process or an aquaculture process or any aerobic culture process, the method comprising:
obtaining a gaseous headspace in an oxygenation or aeration equipment or tank, the gaseous headspace is rich in carbon dioxide;
selecting a portion in the gaseous headspace;
removing at least a fraction of the carbon dioxide in the selected portion by forming a decarbonated gas stream; and
performing one of: returning the decarbonated gas stream to the biological wastewater treatment process, aerobic culture process or aquaculture process, or discharging the decarbonated gas stream.
